(19) United States
(12) Patent Application Publication
(10) Pub. No.: US 2008/0129132 A1
(43) Pub. Date: Jun. 5, 2008

(54) Hermetic compressor

(75) Inventor: Young Su Gwon, Gwangju (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/891,447

(22) Filed: Aug. 10, 2007

(30) Foreign Application Priority Data
Dec. 4, 2006 (KR) 2006-121334

(51) Int. Cl. F04B 17/03; H02K 11/00

(52) U.S. Cl. 310/71

(57) ABSTRACT

A hermetic compressor for achieving a more rapid connection between a stator coil of a drive motor and a power. In the hermetic compressor including at least one stator coil wound on a core of a stator of a drive motor and at least one power line used to apply power to the stator. The stator coil and the power line being connected to each other via a connection band that surrounds corresponding ends of the stator coil and the power line previously aligned with each other. The stator coil is obtained by coating an aluminum wire with an enamel coating layer, and the end of the power line, to be connected to the stator coil, is formed of a stranded wire from which a coating is peeled off. The stranded wire takes the form of a single wire to prevent the stator coil from being inserted thereinto.

### CROSS-REFERENCE TO RELATED APPLICATION

This application claims the benefit of Korean Patent Application No. 10-2006-0121334, filed on Dec. 04, 2006 in the Korean Intellectual Property Office, the disclosure of which is incorporated herein by reference.

### BACKGROUND OF THE INVENTION

1. Field of the Invention

The present disclosure relates to a hermetic compressor, and, more particularly, to a hermetic compressor which can achieve a more rapid connection between a stator coil of a drive motor and a power line, and achieve reduced manufacturing costs.

2. Description of the Related Art

In general, the outer appearance of a hermetic compressor is defined by a hermetic container having a hermetic space therein. A compressing device to compress a refrigerant and a drive motor to operate the compressing device are arranged in the hermetic container.

Specifically, the drive motor serves to provide the compressing device with operating power, and includes a stator mounted fixedly in the hermetic container and a rotor spaced apart inward from the stator and adapted to be rotated via electromagnetic interaction with the stator.

The stator of the drive motor has a plurality of stator coils wound on a core. The stator coils are connected to power lines extended from a terminal block, and in turn the terminal block is coupled to a terminal attached to the hermetic container, for receiving power from an external power source. Conventionally, each stator coil is composed of a single copper wire having an enamel coating layer to prevent short-circuit with another stator coil. The power line is prepared by coating a stranded wire obtained from a bundle of slender copper wires.

Meanwhile, to connect the plurality of stator coils wound on the core to the plurality of power lines extended from the terminal block, respectively, an end of each stator coil and a corresponding end of each power line are connected to each other by use of a connection band.

More specifically, to send electric current into the stator coil connected, at one end thereof, to the end of the corresponding power line, first, the enamel coating layer on the distal end of the stator coil should be peeled off, to expose the copper wire to the outside. Thereafter, similarly, the coating on the corresponding end of the power line is removed to expose the stranded wire to the outside. Finally, the copper wire of the stator coil, from which the enamel coating layer is peeled off, is connected to the stranded wire of the power line by use of the connection band.

However, the above described electric connection between the stator coil and the power line has an inconvenience of delaying the connection operating time because the enamel coating layer has to be peeled off from the stator coil. Further, the copper wire composing the stator coil causes a significant increase in the overall manufacturing costs of the hermetic compressor because of a high price thereof.

### SUMMARY OF THE INVENTION

Therefore, it is an aspect of the disclosure to provide a hermetic compressor which can achieve a more rapid connection between a stator coil of a drive motor and a power line as well as reduced manufacturing costs.

In accordance with an aspect, the present disclosure provides a hermetic compressor comprising at least one stator coil wound on a core of a stator of a drive motor and at least one power line used to apply power to the stator, the stator coil and the power line being connected to each other via a connection band that surrounds corresponding ends of the stator coil and the power line previously aligned with each other, wherein the stator coil is obtained by coating an aluminum wire with an enamel coating layer, the end of the power line, to be connected to the stator coil, is formed of a stranded wire from which a coating is peeled off, the stranded wire taking the form of a single wire to prevent the stator coil from being inserted thereinto, and the connection band is made of an electrically conductive material, and has at least one contact peak formed at an inner surface thereof and configured to pierce the enamel coating layer so as to come into contact with the aluminum wire.

A distal end of the stranded wire, forming the end of the power line, may be subjected to soldering, to provide the end of the power line with a single wire shape.

A terminal member may be coupled to a distal end of the stranded wire forming the end of the power line, to provide the end of the power line with a single wire shape.

The at least one contact peak may include a plurality of contact peaks arranged in a circumferential direction of the connection band.

Each of the contact peaks may have a triangular cross section.

The end of the power line and the end of the stator coil inside the connection band may be connected to each other such that both the ends of the power line and the stator coil come into contact with each other at their circumferential surfaces.

The end of the power line and the end of the stator coil inside the connection band may be linearly connected to each other such that both the ends come into contact with each other at their end surfaces.

The stator coil may be connected to the power line via the connection band in a state in which the end of the stator coil, to be connected to the power line, is coated with the enamel coating layer to prevent the aluminum wire from being exposed to the outside.

Additional aspects and/or advantages of the disclosure will be set forth in part in the description which follows and, in part, will be obvious from the description, or may be learned by practice of the disclosure.

### BRIEF DESCRIPTION OF THE DRAWINGS

These and/or other aspects and advantages of the exemplary embodiments of the disclosure will become apparent and more readily appreciated from the following description of the embodiments, taken in conjunction with the accompanying drawings, of which:

FIG. 1 is a sectional view illustrating the general configuration of a hermetic compressor according to a preferred embodiment of the present disclosure;

FIG. 2 is an exploded perspective view illustrating the connection structure of a stator coil of a stator and a power line of a terminal block in the hermetic compressor of FIG. 1;

FIG. 3 is a perspective view illustrating the configuration of a connection band shown in FIG. 2;

FIG. 4 is a sectional view illustrating a state in which the stator coil and the power line of FIG. 2 are connected to each other by the connection band;

FIG. 5 is a sectional view illustrating the connected state of the stator coil and the power line using the connection band according to another embodiment of the present disclosure; and

FIG. 6 is a sectional view illustrating the connected state of the stator coil and the power line using the connection band according to yet another embodiment of the present disclosure.

### DETAILED DESCRIPTION OF THE PREFERRED EMBODIMENTS

Reference will now be made in detail to a hermetic compressor according to an exemplary embodiment of the present disclosure, examples of which are illustrated in the accompanying drawings, wherein like reference numerals refer to like elements throughout. The embodiment is described below to explain the present disclosure by referring to the figures.

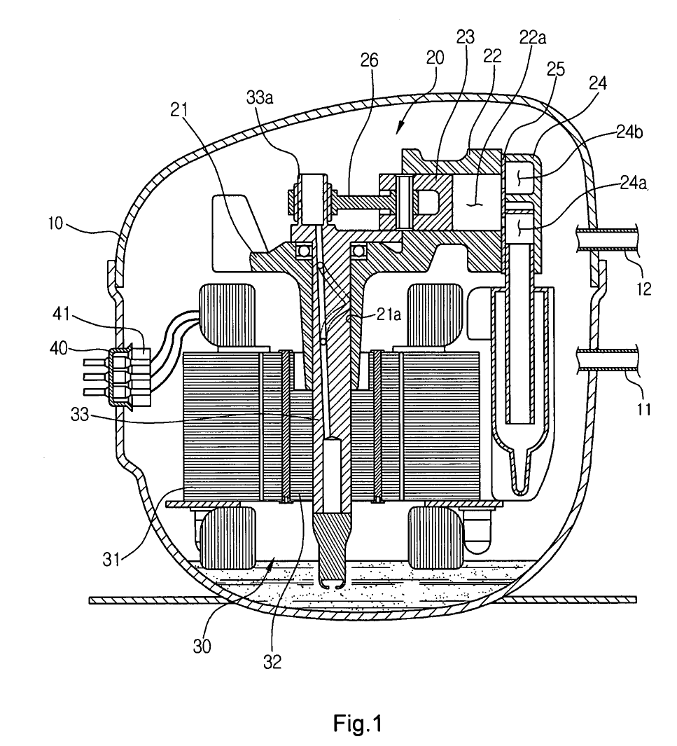

As shown in FIG. 1, the hermetic compressor according to an embodiment of the present disclosure, includes a hermetic container 10 defining a hermetic space therein, a compressing device 20 to compress a refrigerant, and a drive motor 30 to operate the compressing device 20, both the compressing device 20 and the drive motor 30 being arranged in the hermetic container 10. The hermetic container 10 is provided, at opposite sides thereof, with a suction pipe 11 to guide a refrigerant, having passed through an evaporator of a refrigeration cycle, into the hermetic container 10 and with a discharge pipe 12 to guide the refrigerant, compressed within the hermetic container 10, to a condenser of the refrigeration cycle.

The compressing device 20 includes a cylinder 22 integrally formed with a frame 21 and defining a compressing chamber 22a therein, a piston 23 installed to rectilinearly reciprocate in the compressing chamber 22a so as to compress a refrigerant, a cylinder head 24 coupled to an end of the cylinder 22 toward a forward movement direction of the piston 23 so as to hermetically seal the compressing chamber 22a, the cylinder head 24 defining a refrigerant suction chamber 24a and a refrigerant discharge chamber 24b therein, and a valve device 25 interposed between the cylinder 22 and the cylinder head 24 to control the flow of the refrigerant being suctioned from the refrigerant suction chamber 24a into the compressing chamber 22a or being discharged from the compressing chamber 22a into the refrigerant discharge chamber 24b.

Here, the refrigerant suction chamber 24a serves to guide the refrigerant, introduced into the hermetic container 10 through the suction pipe 11, into the compressing chamber 22a. The refrigerant discharge chamber 24b serves to guide the refrigerant, discharged from the compressing chamber 22a, into the discharge pipe 12.

The drive motor 30 serves to rectilinearly reciprocate the piston 23, for the compression of the refrigerant by the compressing device 20. The drive motor 30 includes a stator 31 secured around a lower portion of the frame 21 and adapted to create a magnetic field, and a rotor 32 spaced apart inward from the stator 31 and adapted to be rotated via electromagnetic interaction with the stator 31. The operating power of the drive motor 30 is transmitted to the compressing device 20 via a rotating shaft 33.

Specifically, the rotating shaft 33 is inserted into the frame 21 such that it is rotatably supported in a hollow portion 21a defined in the center of the frame 21. A portion of the rotating shaft 33, below the frame 21, is press-fitted in the center of the rotor 32, to allow the rotating shaft 33 to be rotated together with the rotor 32. An upper end of the rotating shaft 33, protruding upward from the frame 21, defines an eccentric shaft portion 33a to be eccentrically rotated. The eccentric shaft portion 33a is connected to the piston 23 via a connecting rod 26 such that the eccentric rotating motion of the eccentric shaft portion 33a is converted into the rectilinear reciprocating motion of the piston 23.

In the above described configuration, if the stator 31 creates a magnetic field upon receiving electric current, the rotor 32 is rotated via electromagnetic interaction between the stator 31 and the rotor 32. Thereby, as the eccentric shaft portion 33a of the rotating shaft 33 is eccentrically rotated, the piston 23, which is connected to the Is eccentric shaft portion 33a via the connecting rod 26, rectilinearly reciprocates in the compressing chamber 22a, thereby creating a pressure difference between the interior and the exterior of the compressing chamber 22a. With the pressure difference, a refrigerant, which is guided into the hermetic container 10 along the suction pipe 11, is suctioned into the compressing chamber 22a by way of the refrigerant suction chamber 24a. Also, the refrigerant, which is compressed in and discharged from the compressing chamber 22a, is delivered toward the condenser of the refrigeration cycle by way of the refrigerant discharge chamber 24b and the discharge pipe 12.

Meanwhile, to supply electric current to the stator 31, the hermetic container 10 is provided with a terminal 40 that is connected to an external power source. The terminal 40 is coupled to a terminal block 41 inside the hermetic container 10.

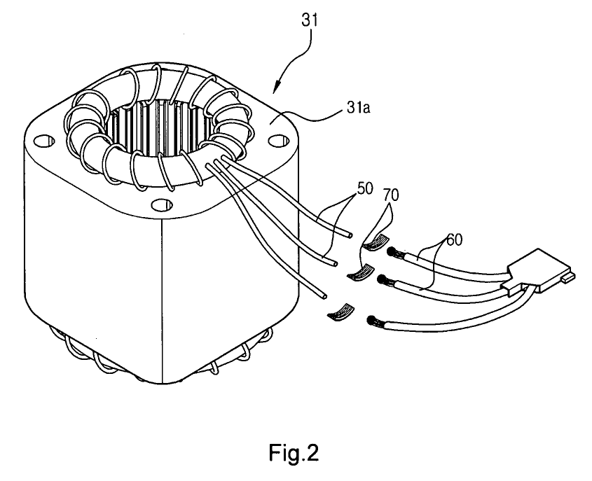

As shown in FIG. 2, the stator 31, constituting the drive motor 30, has a plurality of stator coils 50 wound on a core 31a. Each stator coil 50 is obtained by coating an aluminum wire 51 with an enamel coating layer 52, so as not to cause short-circuit with another stator coil 50. By composing the stator coil 50 of the aluminum wire having a price a third of the price of a copper wire, the hermetic compressor according to the present disclosure can achieve a great reduction in the manufacturing costs thereof.

A plurality of power lines 60 are extended from one end of the terminal block 41 coupled to the terminal 40. Each power line 60 includes a stranded wire 61 prepared by twisting a bundle of slender copper wires, and a coating wire 62 covering the stranded wire 61.

To send electric current to the stator 31, in a state in which one end of the respective stator coils 50 constituting the stator 31 and a corresponding end of the respective power lines 60 extended from the terminal block 41 are aligned with each other, a connection band 70, which is made of an electrically conductive material, is provided to compressively surround the connected ends of the stator coil 50 and the power line 60. Thereby, the stator coil 50 and the power line 60 are connected to each other via the connection band 70. Here, the connection band 70 serves as a conductor for the passage of electric current.

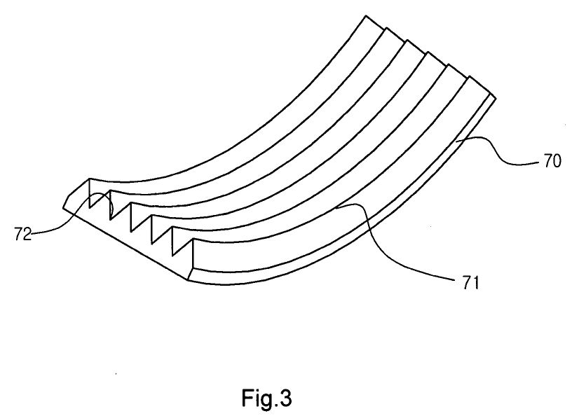

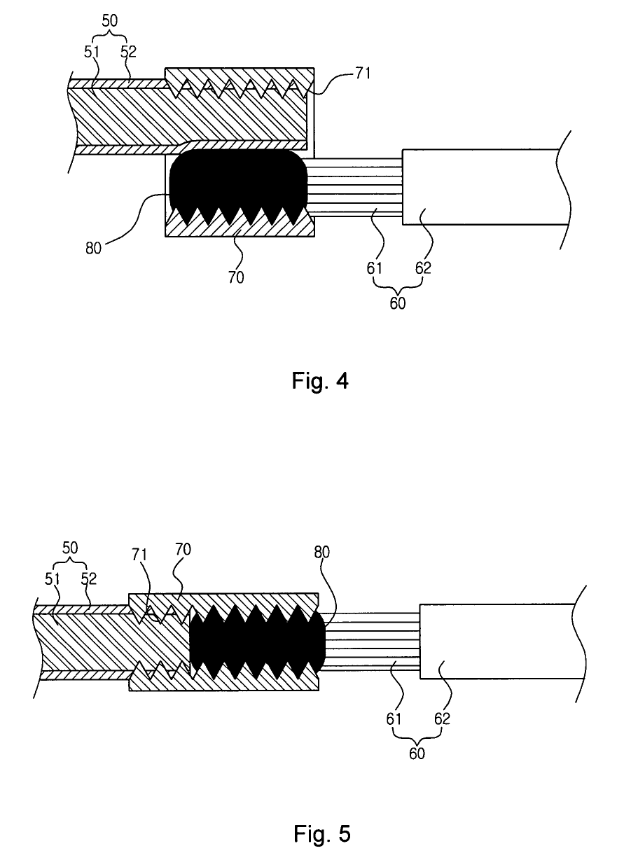

As shown in FIGS. 3 and 4, in the implementation of an operation for connecting the stator coil 50 to the power line 60 in accordance with the present embodiment, the end of the stator coil 50 is connected to the power line 60 in a state in which the enamel coating layer 52 is still coated on the inner aluminum wire 51 so as to prevent the aluminum wire 51 from being exposed to the outside. That is, the stator coil 50 is directly connected to the power line 60 without peeling off the enamel coating layer 52 from the end of the stator coil 50. Also, in the case of the power line 60 to be connected to the stator coil 50, in a state in which the stranded wire 61 at the end of the power line 60, from which the coating wire 62 is peeled off, takes the form of a single wire, the power line 60 is connected to the stator coil 50. The connection band 70 is formed, at an inner surface thereof, with a plurality of contact peaks 71. The contact peaks 71 are configured to pierce the enamel coating layer 52 of the stator coil 50 so as to come into contact with the aluminum wire 51 inside the enamel coating layer 52 when the connection band 70 compressively surrounds the stator coil 50.

The above described connection structure between the stator coil 50 and the power line 60 according to the present embodiment has the effect of omitting an operation for peeling off the enamel coating layer 52 from the end of the stator coil 50, and consequently, guaranteeing a more simplified connection between the stator coil 50 and the power line 60.

As known, a copper wire has a tensile strength of 22 kg/mm² at a room temperature, whereas a tensile strength of an aluminum wire is only 10 kg/mm². Therefore, if the enamel coating layer 52 is peeled off from the stator coil 50, there is a risk that the aluminum wire 51 having a low tensile strength may be broken when a tensile force is applied to the stator coil 50. However, by connecting the stator coil 50 to the power line 60 without peeling off the enamel coating layer 52 covering the aluminum wire 51 from the end of the stator coil 50 to be connected to the lower line 60 as described above, it is possible to prevent degradation in the tensile and bending strengths of the connecting region of the stator coil 50.

Meanwhile, the contact peaks 71, formed at the inner surface of the connection band 70, are configured to pierce the enamel coating layer 52 of the stator coil 50, so as to come into contact with the aluminum wire 51 enclosed by the enamel coating layer 52 as the connection band 70 compressively surrounds the stator coil 50.

The plurality of contact peaks 71 are arranged in a circumferential direction of the connection hand 70 such that a plurality of valleys 72 are defined between the plurality of contact peaks 71 in a circumferential direction of the connection band 70.

Each contact peak 71 has a pointed end to allow the contact peak 71 to easily pierce the enamel coating layer 52 of the stator coil 50 when the connection band 70 is pressed onto the stator coil 50. In the present embodiment, the contact peak 71 has a triangular cross section such that the end of the contact peak 71 can easily pierce the enamel coating layer 52 of the stator coil 50.

With the use of the above described contact peaks 71, the stator coil 50 can be electrically conductively connected to the power line 60 via the connection band 70 when the connection band 70 is pressed onto the stator coil 50 and the power line 60 without peeling off the enamel coating layer 52. In a state in which the end of the stator coil 50 and the stranded wire 61 at the end of the power line 60 are connected to each other inside the connection band 70 while being caught by the contact peaks 71, it is possible to prevent the ends of the stator coil 50 and the power line 60 from being separated out of the connection hand 70. Accordingly, there is no risk that the stator coil 50 and the power line 60 connected to each other are unintentionally separated out of the connection band 70.

Meanwhile, in the case where the connection band 70 has a somewhat narrow width, it is general that the ends of the power line 60 and the stator coil 50 are connected to each other inside the connection band 70 such that both the ends of the power line 60 and the stator coil 50 are overlapped one above another to come into contact with each other at their circumferential surfaces. In such an overlapped contact state, however, the stranded wire 61 inside the connection band 70 may be spread out in the course of being compressively surrounded by the connection band 70. This has a risk of causing the end of the stator coil 50 to be inserted into the stranded wire 61, thus making it difficult for the contact peaks 71 of the connection band 70 to pierce the enamel coating layer 52 of the stator coil 50. Accordingly, it is difficult to achieve an electrically conductive connection between the stator coil 50 and the power line 60.

To solve the above problem, the stranded wire 61 at the end of the power line 60, to be connected to the stator coil 50, takes the form of a single wire so as not to be spread out. For this, in the present embodiment, the stranded wire 61 is subjected to soldering, to form a solder joint 80 at a distal end thereof. Consequently, the end of the power line 60 is primarily aligned with the end of the stator coil 50 via the solder joint 80, and secondarily connected to the stator coil 50 via the connection band 70. In this way, the hermetic compressor according to the present embodiment can achieve direct connection between the stator coil 50 and the power line 60 without peeling of the stator coil 50, and furthermore prevent the end of the stator coil 50 from being inserted into the stranded wire 61 at the end of the power line 60, resulting in an efficient reduction in the possibility of poor electric conduction between the stator coil 50 and the power line 60.

As shown in FIG. 5, in another embodiment of the present disclosure in which the connection band 70 has a somewhat long length, the power line 60 and the stator coil 50 can be linearly connected to each other by the connection band 70 even in a state in which both the ends come into contact with each other at their end surfaces. In this case, similarly, the end of the stator coil 50 is supported by the solder joint 80 so as not to be inserted into the stranded wire 61, and there is no risk of hindering electric conduction between the stator coil 50 and the lower line 60.

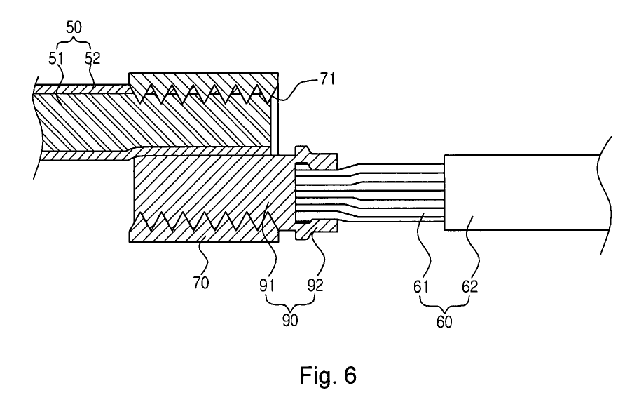

Referring to FIG. 6 illustrating yet another embodiment of the present disclosure, the stranded wire 61 at the end of the power line 60 has a single wire shape, and a terminal member 90 is coupled to the distal end of the stranded wire 61.

The terminal member 90 is made of a cylindrical electrically conductive material, and has a connector portion 91 and a coupler portion 92 formed at opposite ends thereof. Specifically, the connector portion 91 is connected to the stator coil 50, and the coupler portion 92 acts to couple the terminal member 90 to the stranded wire 61. For this, the coupler portion 92 is compressively deformable in a state in which the distal end of the stranded wire 61 is inserted thereinto.

Similarly, in the present embodiment, if the connector portion 91 of the terminal member 90 is connected to the end of the stator coil 50 via the connection band 70 in a state in which the terminal member 90 is coupled to the distal end of the stranded wire 61 at the end of the power line 60, the stator coil 50 can be directly connected to the power line 60 without peeling of the stator coil 50. Also, it is possible to prevent the end of the stator coil 50 from being inserted into the stranded wire 61. As a result, the present embodiment can achieve a great reduction in the possibility of poor conduction between the stator coil 50 and the power line 60.

As apparent from the above description, according to a hermetic compressor of the present disclosure, a stator coil can be electrically conductively connected to a power line by use of a connection band without peeling of the stator coil. As a result, a more simplified connection between the stator coil and the power line can be accomplished.

Further, the stator coil is formed of an aluminum wire that is cheaper than a copper wire. Accordingly, the hermetic compressor according to the present disclosure can achieve a great reduction in the overall manufacturing costs thereof.

Although an embodiment of the present disclosure has been shown and described, it would be appreciated by those skilled in the art that changes may be made in this embodiment without departing from the principles and spirit of the disclosure, the scope of which is defined in the claims and their equivalents.

What is claimed is:

1. A hermetic compressor comprising at least one stator coil wound on a core of a stator of a drive motor and at least one power line used to apply power to the stator, the stator coil and the power line being connected to each other via a connection band that surrounds corresponding ends of the stator coil and the power line previously aligned with each other, wherein
the stator coil is obtained by coating an aluminum wire with an enamel coating layer,
the end of the power line, to be connected to the stator coil, is formed of a stranded wire from which a coating is peeled off, the stranded wire taking the form of a single wire to prevent the stator coil from being inserted thereinto, and
the connection band is made of an electrically conductive material, and has at least one contact peak formed at an inner surface thereof and configured to pierce the enamel coating layer so as to come into contact with the aluminum wire.

2. The hermetic compressor according to claim 1, wherein a distal end of the stranded wire, forming the end of the power line, is subjected to soldering, to provide the end of the power line with a single wire shape.

3. The hermetic compressor according to claim 1, wherein a terminal member is coupled to a distal end of the stranded wire forming the end of the power line, to provide the end of the power line with a single wire shape.

4. The hermetic compressor according to claim 1, wherein the at least one contact peak includes a plurality of contact peaks arranged in a circumferential direction of the connection band.

5. The hermetic compressor according to claim 4, wherein each of the contact peaks has a triangular cross section.

6. The hermetic compressor according to claim 1, wherein the end of the power line and the end of the stator coil inside the connection band are connected to each other such that both the ends are overlapped to come into contact with each other at their circumferential surfaces.

7. The hermetic compressor according to claim 1, wherein the end of the power line and the end of the stator coil inside the connection band are linearly connected to each other such that both the ends come into contact with each other at their end surfaces.

8. The hermetic compressor according to claim 1, wherein the stator coil is connected to the power line via the connection band in a state in which the end of the stator coil, to be connected to the power line, is coated with the enamel coating layer to prevent the aluminum wire from being exposed to the outside.
